(19) United States
(12) Patent Application Publication
(10) Pub. No.: US 2015/0068761 A1
(43) Pub. Date: Mar. 12, 2015

(54) Subterranean Storage Assemblies and Methods for Storing Fluids in a Subterranean Room

(71) Applicant: NEP IP, LLC, Sheridan, WY (US)

(72) Inventors: Joseph McPhie, Ranchester, WY (US); Joshua Walton, Sheridan, WY (US); Jason Todd, Ranchester, WY (US); Robert Ferri, Cody, WY (US)

(21) Appl. No.: 14/020,769

(22) Filed: Sep. 6, 2013

(51) Int. Cl. E21B 43/00; E21B 17/00; B65G 5/00; B65D 21/02

(52) U.S. Cl. CPC E21B 43/00; B65D 21/0201; E21B 17/00; B65G 5/00
USPC 166/370; 166/75.11; 166/369

(57) ABSTRACT

Subterranean hydrocarbon recovery systems are provided with the systems including a plurality of conduit sections in fluid communication with at least some of which being aligned in parallel along at least one axis of each section. The recovery systems can also include a well head within a subterranean space with at least one of the sections being in fluid communication with the well head. Subterranean hydrocarbons systems are also provided that can include a plurality of conduit sections arranged in rows and columns.

### TECHNICAL FIELD

The present disclosure relates to subterranean storage assemblies and methods for storing fluids in subterranean rooms. In some embodiments, the method relates to modular systems that can be used to establish a subterranean fluid storage assembly, and the fluid that may be stored may be in gas or liquid form.

### BACKGROUND

Petroleum products such as gas and/or liquid products may be acquired from subterranean rooms through the walls, ceilings, or surfaces of those rooms via different well drilling and pumping techniques. Storage of these liquids within these rooms can be more problematic as the rooms do not have a large amount of space and/or it is difficult to get tanks into these rooms from above ground level. The present disclosure provides subterranean storage assemblies and methods for storing fluids in a subterranean room.

### SUMMARY OF THE DISCLOSURE

Subterranean hydrocarbon recovery systems are provided with the systems including a plurality of conduit sections in fluid communication with at least some of which being aligned in parallel along at least one axis of each section. The recovery systems can also include a well head within a subterranean space with at least one of the sections being in fluid communication with the well head. Subterranean hydrocarbons systems are also provided that can include a plurality of conduit sections arranged in rows and columns.

Methods for recovering hydrocarbon within a subterranean space can include transferring hydrocarbon from at least part of the earth surrounding the space to a plurality of conduit sections within the space. Methods for providing hydrocarbon storage within a subterranean space can also include providing a plurality of sections of conduit to within the space, configuring the conduit to be in fluid communication and form a system of a plurality of conduit sections, and/or providing hydrocarbon from the earth surrounding the space to within the system of conduit.

### DRAWINGS

Embodiments of the disclosure are described below with reference to the following accompanying drawings.

FIG. 1 is a depiction of a subterranean room housing a subterranean fluid storage assembly.

FIG. 2 is another depiction of another room housing another configuration of a subterranean storage assembly.

FIG. 3 is yet another configuration of a subterranean storage assembly.

FIG. 4 is a depiction of yet another configuration of the subterranean storage assembly.

FIG. 5 is another configuration of a subterranean storage assembly.

FIG. 6 is yet another configuration of a subterranean storage assembly.

FIG. 7 is yet another configuration of a subterranean storage assembly.

### DESCRIPTION

This disclosure is submitted in furtherance of the constitutional purposes of the U.S. Patent Laws “to promote the progress of science and useful arts” (Article 1, Section 8).

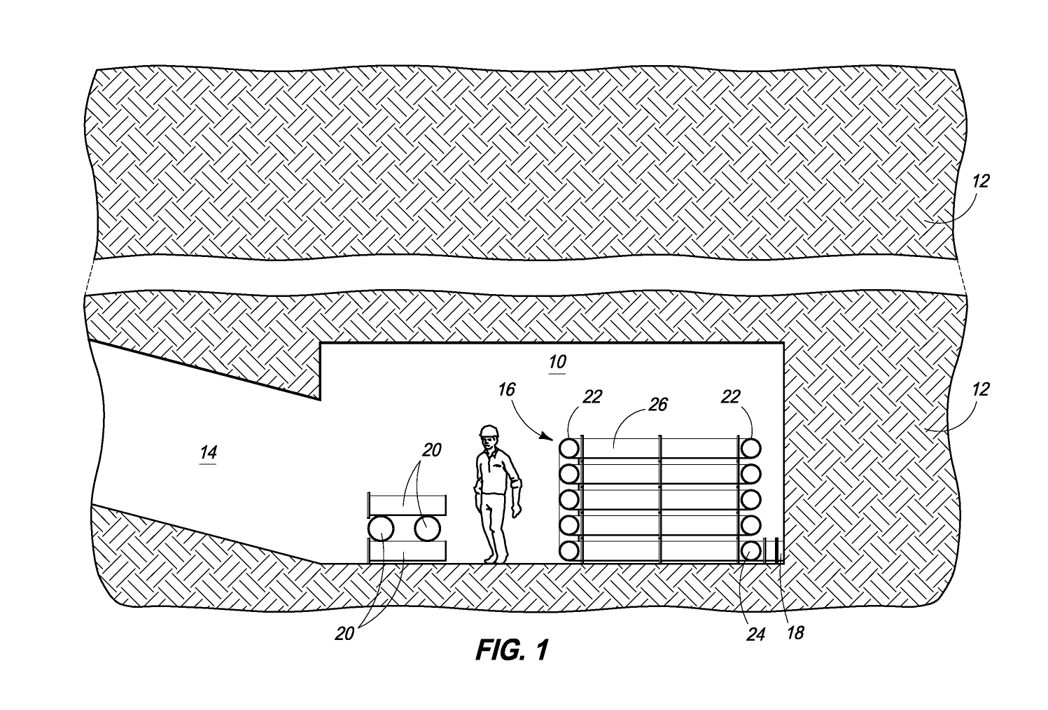

The assemblies and methods of the present disclosure will be described with reference to FIGS. 1-7. Referring first to FIG. 1, subterranean room 10 can be located within earth 12 and may have access tunnel 14 connected thereto. Within room 10 can be storage assembly 16, which can be in fluid communication with well head 18 entering earth 12, for example. As can be seen in FIG. 1, sections of conduit 20 may be arranged separately for future incorporation into assembly 16 as desired. In accordance with example embodiments, sections 20 can be considered individual pipe segments, and these can be configured to run parallel relative to one another in some embodiments to provide close packing and configuration of assembly 16. These sections or segments need not be connected at their respective ends and may be stubbed off at their ends and/or connected with T-like connectors that may be displaced from the sealed, stubbed off ends. These segments may be arranged horizontally and/or vertically as desired.

In horizontal arrangements, the inflow may be associated with a lower portion and/or upper portion as desired. In accordance with example implementations, as gravity provides fluid to the assembly, the fluid may rise from the lower portion of the assembly towards the upper portion of the assembly.

In some implementations, the assembly may be static. In other implementations, the system may include a pump in fluid communication with the well head with at least a portion of the assembly therebetween. The pump can be configured to facilitate the flow of fluid from the well head into the assembly.

According to example configurations, the assembly may be configured to contain as much as 50 to 120 barrels of fluid. In some implementations, greater than 50 barrels of fluid is desirable. Sections 20 can be greater than 6″ in diameter to less than 2′ in diameter, and the space in between these conduits within the assembly can be about 1.5 times the diameter or greater than 1.5 times the diameter of the sections. In accordance with example implementations, these assemblies can include cleanouts or catches that may be formed at bottom portions of the vertical members. Vertical members can connect horizontal members as well.

In accordance with example implementations, assembly 16 can include a plurality of conduit sections in fluid communication. At least some of the sections can be aligned in parallel along at least one axis of each section. As an example, sections 22 of assembly 16 are aligned in parallel along at least one axis of each section. In accordance with example implementations, section 24 may be lowest in elevational relation to the remaining sections of assembly 16, for example, and this section may be connected with well head 18. As can be seen, at least some of the sections of assembly 16 are cylindrical, in that they have the traditional pipe configuration.

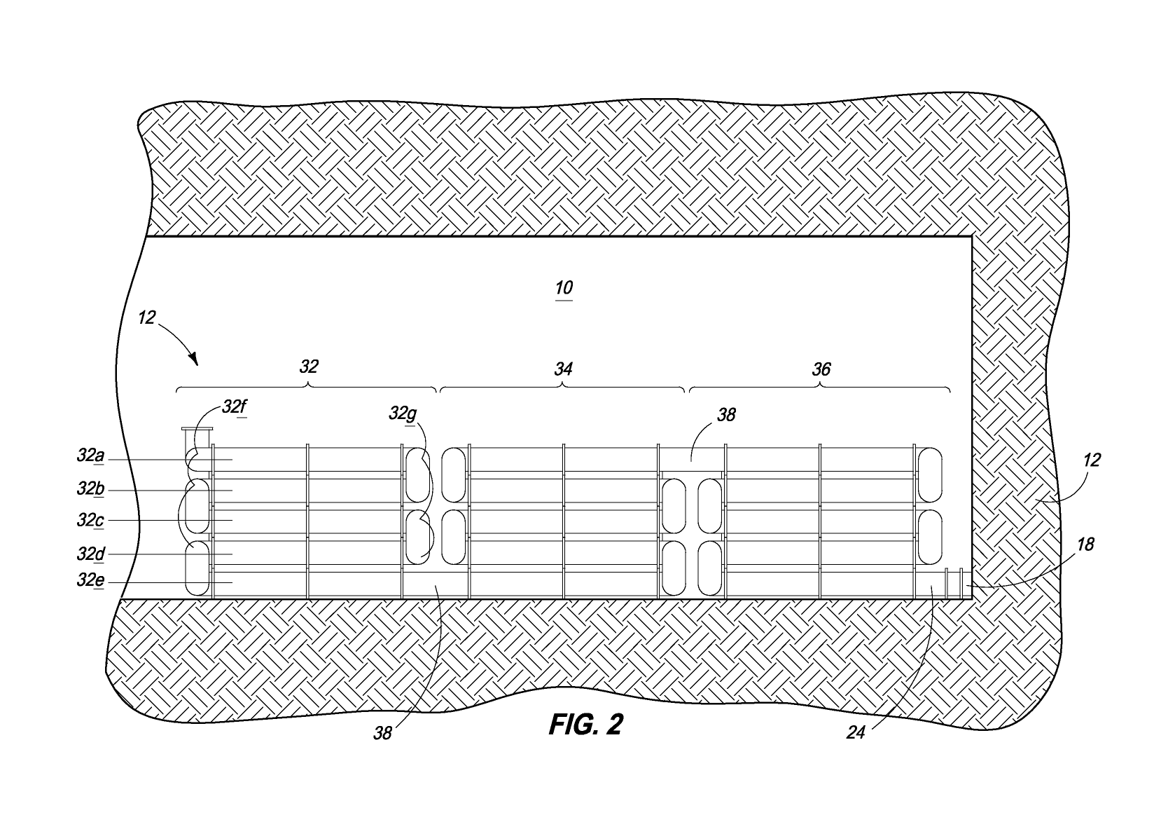

Referring to FIG. 2, for example, system 12 can include a plurality of conduit sections arranged in rows and columns. As shown in FIG. 2, assemblies can be discrete yet in fluid communication with one another. As an example, subassemblies 32, 34, and 36 can be arranged with spacing therebetween. Individual ones of these subassemblies may or may not have conduit sections arranged in rows or columns as shown. Referring to subassembly 32, rows of conduits can include rows 32A-32E, and columns of conduits can include 32F and 32G, for example. In accordance with example implementations, room 10 can include well head 18 and at least one of the sections of one of the subassemblies can be connected to well head 18. In accordance with example implementations, the columns 32F and 32G may or may not be offset from one another and in elevational relationship and/or in at least one cross section. The columns and/or rows of these sections may be in fluid communication. As can be seen in FIG. 2, subassemblies 32, 34, and 36 may be connected by additional sections 38 providing fluid communication between each.

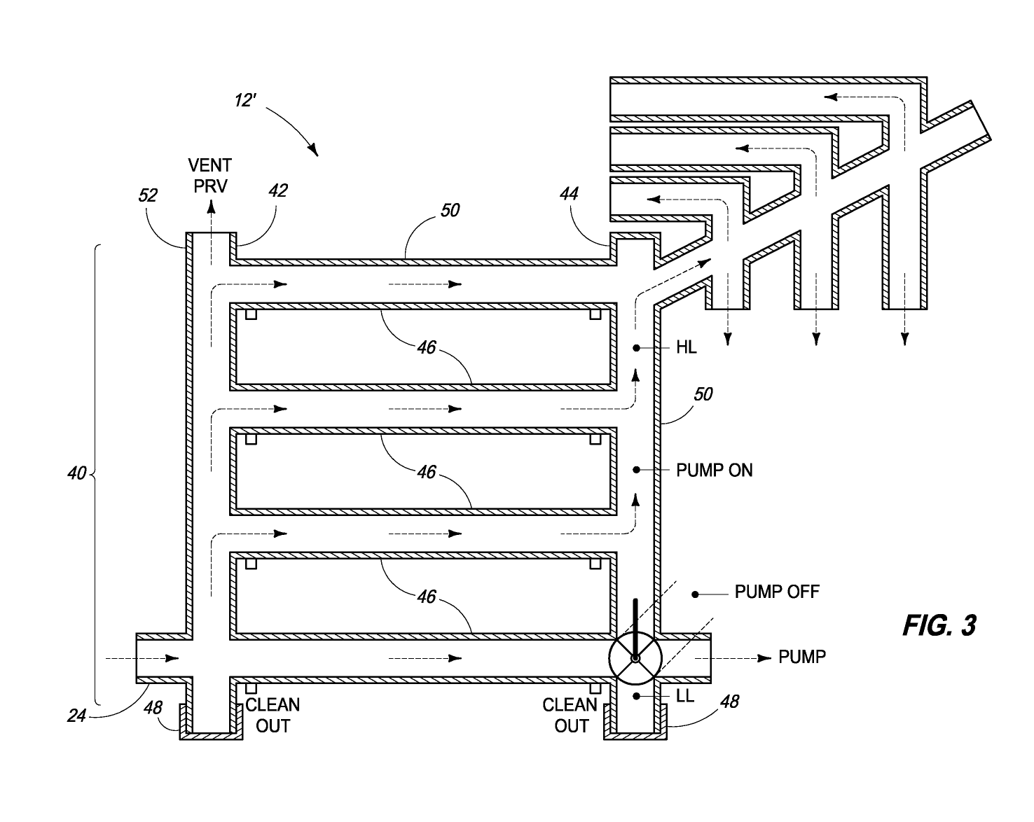

Referring next to FIG. 3, system 12 can include a laddered plurality 40 of conduit sections in fluid communication. Again, the well head may be coupled to this configuration within a subterranean space at, for example, section 24. The laddered plurality may include rung sections as well as rail sections. Rail sections 42 and 44 can be connected by rung sections 46, for example.

In accordance with example implementations, rung sections 42 and/or 44 can include a monitoring system that may be utilized to determine the fluid level within the assembly. This monitoring system can take the form of a viewing level and may be at one or more points along rung 42 or 44, for example. An upper ladder section may also include this monitoring system as well. The monitoring system may be a certain gas indicator and/or simply a fluid viewing portal, for example.

The monitoring system may be operationally coupled to a pump, and the pump may be configured to operate providing fluid to the assembly and/or ceasing fluid flow to the assembly.

In accordance with example configurations, the rail sections might also include cleanout portals 48, which may be used to remove material from the assembly upon multiple uses and/or as desired. As can be seen, the rail sections can include monitoring systems 50. System 12 may also include a pressure gauge associated therewith. In accordance with example implementations, system 12 can include a vent 52, and the pressure gauge may be associated therewith. In accordance with example implementations, at least one of the rail sections may terminate in vent 52.

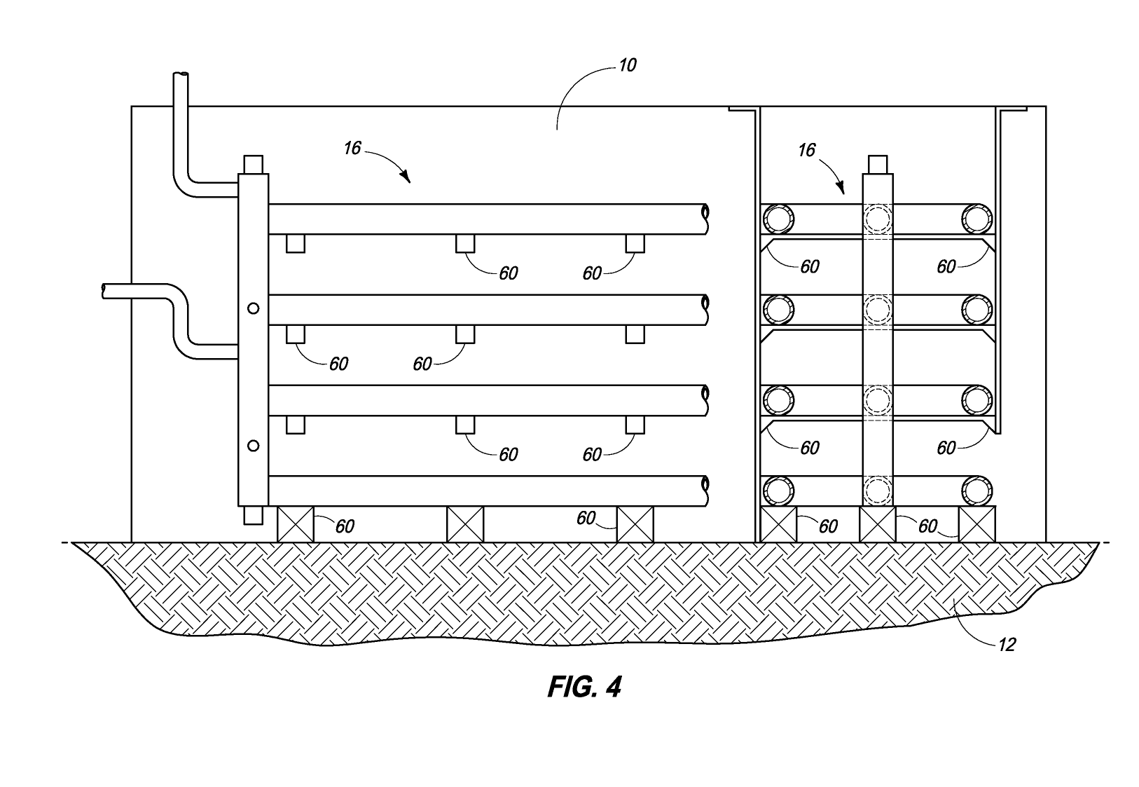

Referring next to FIG. 4, a plurality of sections may be transferred to a subterranean space 10, and these sections assembled to form assembly 16. FIG. 4 demonstrates at least two assemblies within room 10, a portion of one assembly configured in one longitudinal direction, and a portion of another assembly configured in another longitudinal direction. As can be seen, these assemblies can include supports 60. These supports can be utilized to support the conduit within room 10, for example.

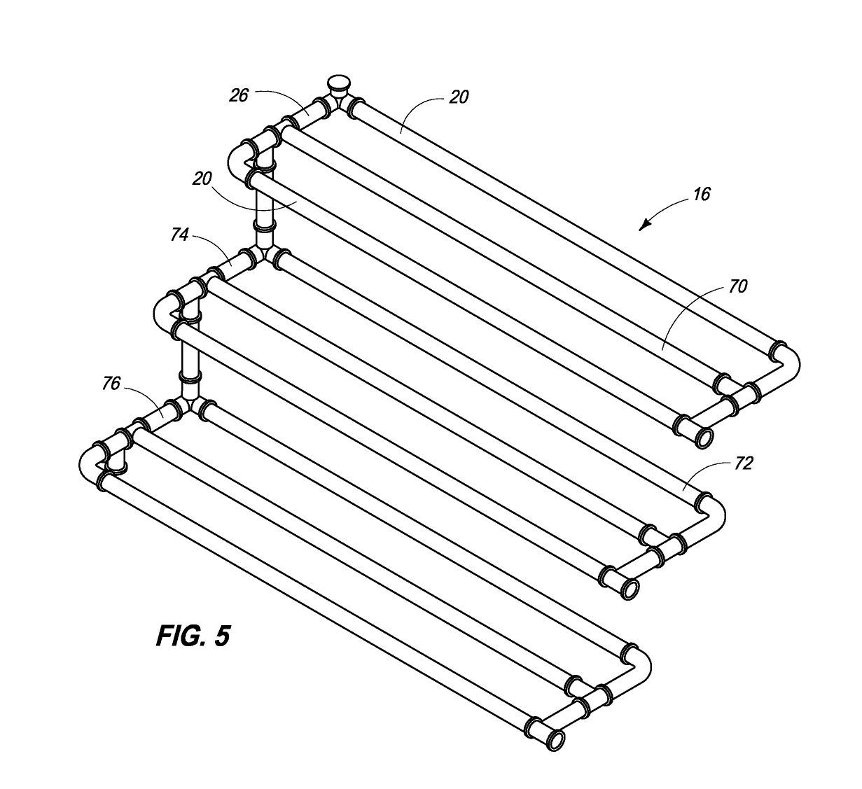

Referring next to FIG. 5, as can be seen, according to another embodiment, assembly 16 can be configured to be juxtaposed with individual subassemblies juxtaposed from one another, and allowing for compaction of the assemblies within one another. As can be seen in detail here, sections 20 can be substantially normal to sections 26, for example. While some of these sections are aligned vertically in columns in one cross section, for example, sections 70 and 72, other sections are aligned in rows in the same cross section such as sections 74 and 76.

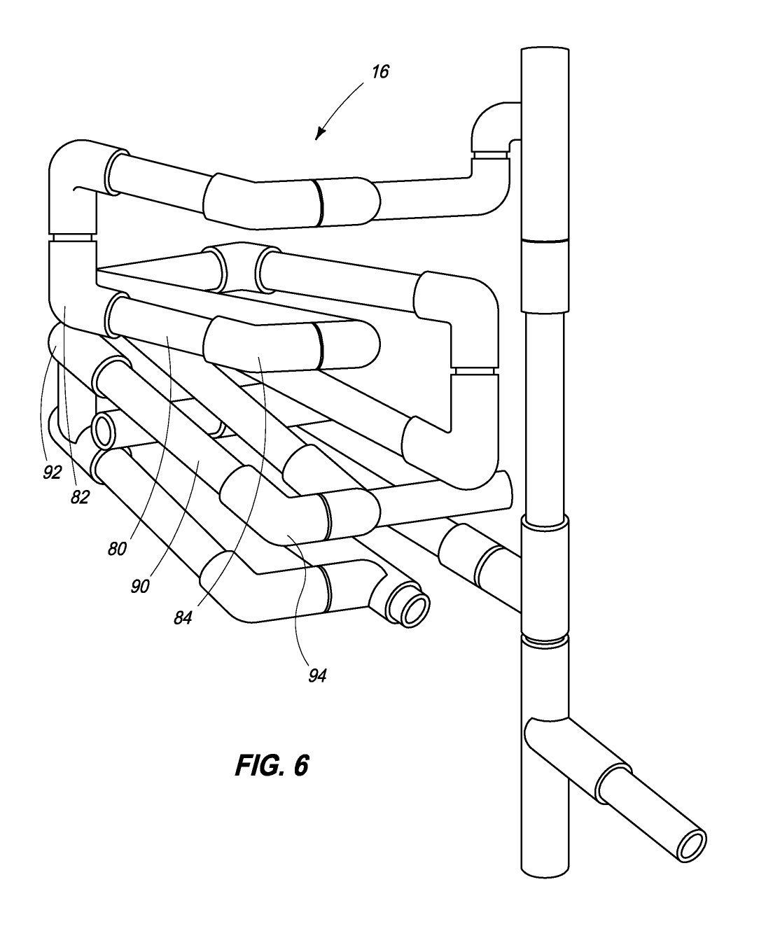

Referring to FIG. 6, another embodiment of system 16 is shown demonstrating angled differences between sections of conduit within the same system. For example, section 80 terminating in ends 82 and 84 has a substantially non-parallel relation to section 90 terminating in ends 92 and 94. According to example implementations, this relation can facilitate close packing of the sections.

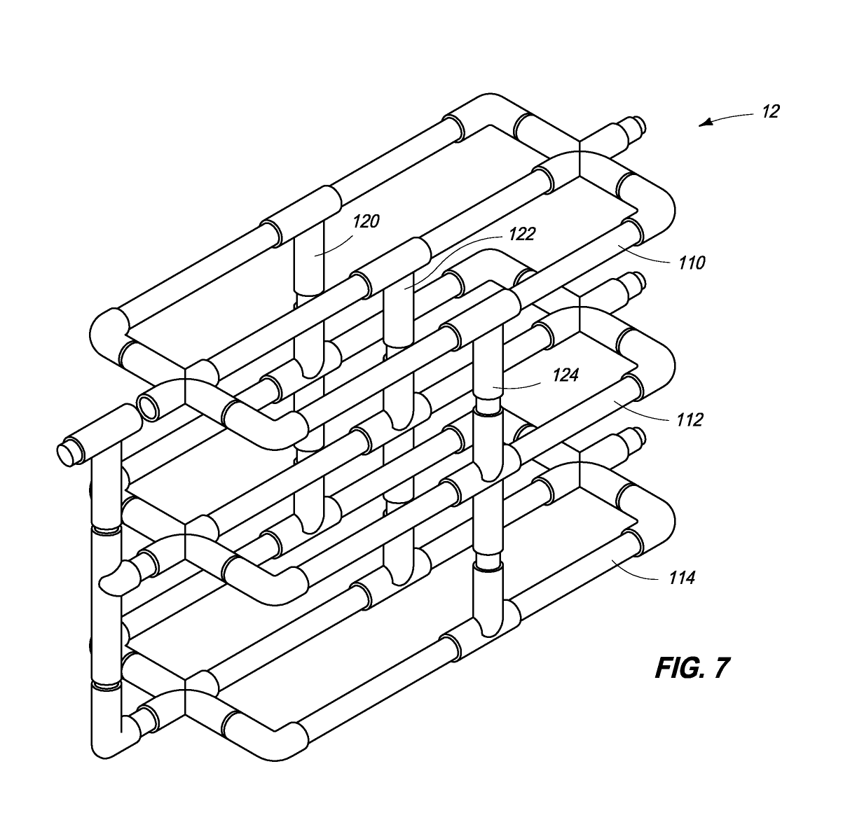

Referring lastly to FIG. 7, yet another configuration of assembly 12 is shown that includes multiple rows 110, 112, 114, and columns 120, 122, 124, and/or ladders of rungs 110, 112, 114 and rails 120, 122, 124 of conduit arranged in substantially a racked assembly having multiple interconnections in between forming different subassemblies of the conduit, thereby providing more space for fluid to be stored in the assembly.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A subterranean hydrocarbon recovery system, the system comprising:
a plurality of conduit sections in fluid communication, at least some of which are aligned in parallel along at least one axis of each section; and
a well head within a subterranean space, at least one of the sections being in fluid communication with the well head.

2. The system of claim 1 wherein at least some of the sections extend along an axis wherein one end of the section defines a different elevation than the opposing other end of the section along the axis.

3. The system of claim 1 further comprising sections aligned substantially normal to other sections.

4. The system of claim 1 wherein the one section is in fluid communication with the well head, the one section being lowest in elevational relation to the remaining sections of the system.

5. The system of claim 1 wherein at least some of the sections are cylindrical.

6. A subterranean hydrocarbon recovery system, the system comprising:
a plurality of conduit sections arranged in rows and columns; and
a well head within a subterranean space, at least one of the sections being in fluid communication with the well head.

7. The system of claim 6 wherein the columns are offset from one another in at least one cross section.

8. The system of claim 6 wherein the columns of sections are in fluid communication.

9. The system of claim 6 wherein the rows of sections are in fluid communication.

10. The system of claim 6 further comprising additional sections establishing fluid communication between the rows and/or columns.

11. A subterranean hydrocarbon recovery system, the system comprising:
a laddered plurality of conduit sections in fluid communication; and
a well head within a subterranean space, at least one of the sections being in fluid communication with the well head.

12. The system of claim 11 wherein the laddered plurality comprises rail sections extending vertically and rung sections extending horizontally between the rails.

13. The system of claim 12 wherein at least one of the rail sections includes an assembly configured to indicate the presence of hydrocarbon within the rail.

14. The system of claim 13 wherein the assembly comprises a viewing member.

15. The system of claim 13 wherein the assembly comprises a gauge.

16. The system of claim 12 wherein at least one of the rail sections terminates in a vented opening.

17. A method for recovering hydrocarbon within a subterranean space, the method comprising:
providing a plurality of individual sections of conduit to within a subterranean space;
constructing a recovery system from the conduit; and
transferring hydrocarbon from at least part of the earth surrounding the space to the system of conduit sections within the space.

18. The method of claim 17 wherein the constructing the recovery system comprises arranging the conduit into a plurality of columns and rows, at least some of the columns and rows being in fluid communication with one another.

19. The method of claim 17 wherein the constructing the recovery system comprises arranging the conduit into a plurality of ladder configurations, at least some of the ladder configurations being in fluid communication with one another.

20. The method of claim 17 wherein the transferring hydrocarbon comprises providing a pressure differential between the earth surrounding the space and the system.
